(19) United States
(12) Patent Application Publication
(10) Pub. No.: US 2010/0020732 A1
(43) Pub. Date: Jan. 28, 2010

(54) PHYSICAL LAYER SUPERFRAME, FRAME, PREAMBLE AND CONTROL HEADER FOR IEEE 802.22 WRAN COMMUNICATION SYSTEMS

(75) Inventors: Vasanth R. Gaddam, Tarrytown, NY (US); Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/441,595

(22) PCT Filed: Sep. 21, 2007
(86) PCT No.: PCT/IB2007/053845

§ 371 Date: Mar. 17, 2009

Related U.S. Application Data
(60) Provisional application No. 60/826,985, filed on Sep. 26, 2006.

(51) Int. Cl. H04L 12/28; H04B 7/00

(52) U.S. Cl. 370/310; 370/431

(57) ABSTRACT

The present invention provides a system (900), apparatus (700, 800) and method for frames, preambles and control headers for a physical (PHY) layer of the 802.22 WRAN specification. Some of the main features of the present invention include: Superframe and Frame structure; Superframe Preamble (and CBP Preamble); Frame Preamble; Superframe Control Header (SCH); and Frame Control Header (FCH).

This invention relates to a physical layer (PHY) for IEEE 802.22 WRAN systems. More particularly this invention provides superframe and frame structures for a PHY layer of WRAN systems. Most particularly, this invention provides superframe, frame, preamble, and control header for WRAN communication systems.

Remote areas where wired infrastructure is limited are traditionally better served by wireless communication technology. As elsewhere, in remote areas there are dedicated or licensed portions as well as unlicensed portion of the communications spectrum. Only a small portion of the licensed bands is being used, while the unlicensed portion is freely accessible. One option for increasing use of licensed bands by dynamically access the communications spectrum in the spectrum normally dedicated for television transmission and reception. Typically, regulatory bodies require that an unlicensed user (a secondary user) vacate a channel in a relatively short period of time after an incumbent user (licensed primary user) begins occupation of the channel. Therefore, the medium access control (MAC) and physical (PHY) layer specifications must include provisions directed to managing the use of allocated spectrum by unlicensed users.

The IEEE 802.22 working group is chartered to develop a standard for a cognitive radio-based PHY/MAC/air_interface for use by license-exempt devices on a non-interfering basis in spectrum that is allocated to the TV Broadcast Service. In this regard, the working group has issued a call for proposals (CFP) requesting submissions of proposals towards the selection of technologies for the initial 802.22 Specification. One of the applications where the standard can be used is in wireless regional area networks (WRANs). Such service is directed to bringing broadband access to rural and remote areas by taking advantage of unused TV channels extant in these sparsely populated areas.

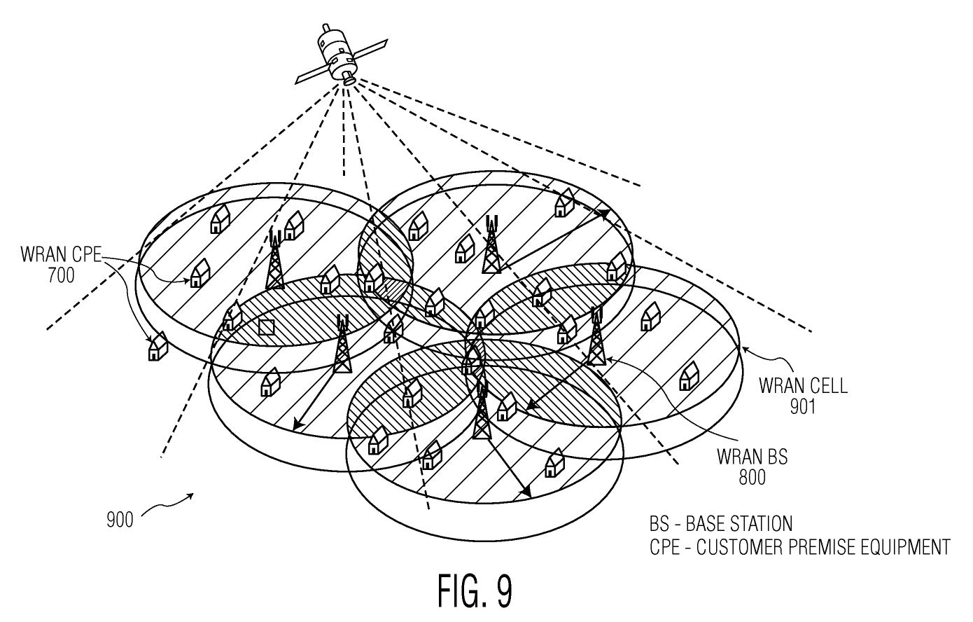

The IEEE 802.22 WRAN standard specifies a fixed point-to-multipoint (P-MP) wireless air interface whereby a base station (BS) 800 manages its cell 901 and all associated consumer premise equipments (CPEs) 700, as illustrated in FIG. 9. In such a WRAN, the BS includes MAC and PHY layer stacks and supporting spectrum management modules configured to allocate each of the stacks to one of an available unused TV channel and a set of contiguous available unused TV channels. The BS 800 controls unused TV channel access in its cell 901 and transmits in the downstream direction to the various CPEs 700 in its cell. The CPEs 700 in the cell 901 of a BS 800, respond back to the BS 800 in the upstream direction.

In addition to the conventional role of a BS 800, the BS also manages a feature unique to WRANs, namely, distributed sensing. The BS 800 instructs the various CPEs 700 in its cell 901 to perform distributed measurement of different TV channels. Based on the responses received by the BS 800 from the CPEs 700, the BS 800 determines which spectrum management actions to take. The primary consideration is that the license-exempt devices (CPEs) avoid interference with incumbent TV broadcasting.

Operation of WRAN systems is based on fixed wireless access being provided by the BSs 800 operating under a universally accepted standard that controls the radio-frequency (RF) characteristics of the CPEs 700. The CPEs 700 are expected to be readily available from consumer electronic stores, not need to be licensed or registered, include interference sensing and be installed by a user or by a professional. A CPE 700 is expected to be an RF device based on low-cost UHF-TV tuners. The RF characteristics of the CPE 700 are under total control of the BS 800 but, as indicated above, RF signal sensing is expected to be accomplished by the BS 800 and the CPEs 700 under management by the BS 800. The latter centralized control allows a BS 800 to aggregate the TV sensing information centrally and take action at the system level to avoid interference, e.g., change frequency and make more efficient use of unused TV spectrum, e.g., bond contiguous unused TV channels.

Thus, a wireless air interface, i.e., MAC and PHY, is needed that is based on cognitive radio concepts for IEEE 802.22 WRAN systems. Both the MAC and the PHY must offer high performance while maintaining low complexity, exploiting the available frequency efficiently. One of the proposals to IEEE 802.22 is based on OFDMA modulation for both downstream and upstream links with technological improvements including channel bonding.

The present invention provides definitions of superframe, frame, preambles and control headers, for a physical (PHY) layer of the 802.22 WRAN specification. Some of the main features of the present invention include:
1) Superframe and Frame structure;
2) Superframe Preamble (and CBP preamble);
3) Frame Preamble;
4) Superframe Control Header (SCH); and
5) Frame Control Header (FCH).
   The superframe includes preamble and control header transmitted in parallel over at least one contiguous TV channel occupied by a BS and synchronizing with CPEs receiving the superframe and preamble by sensing the at least one contiguous TV channel. Alternatively, the superframe and preamble include information of the TV channels occupied by the BS.

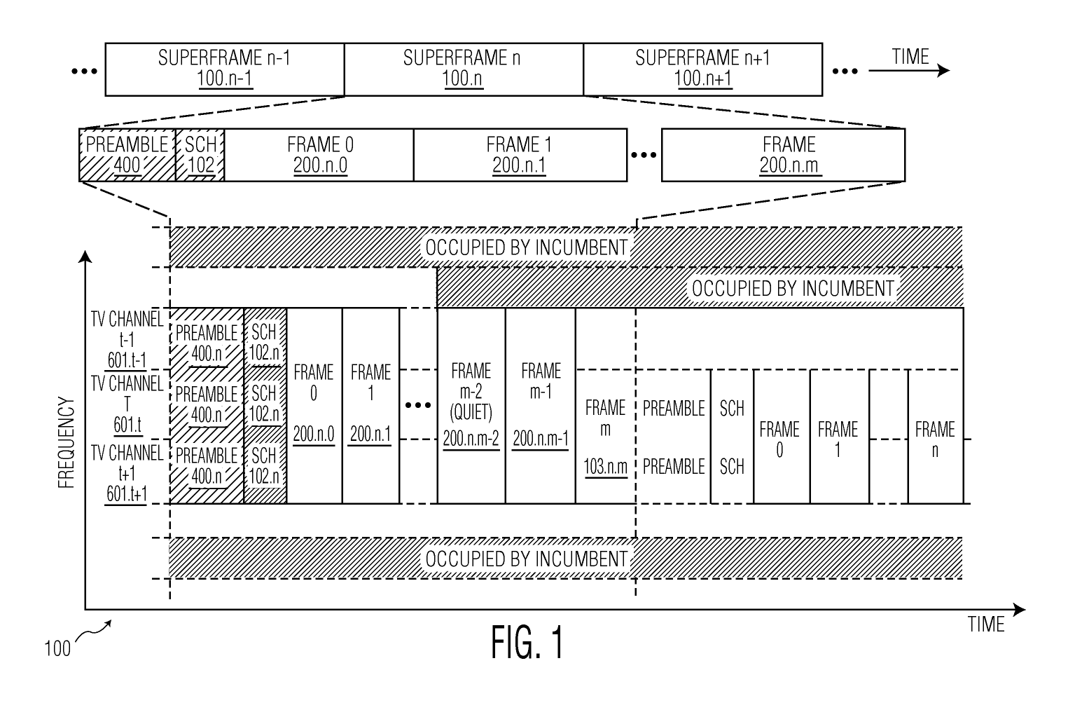

FIG. 1 illustrates superframe structure;

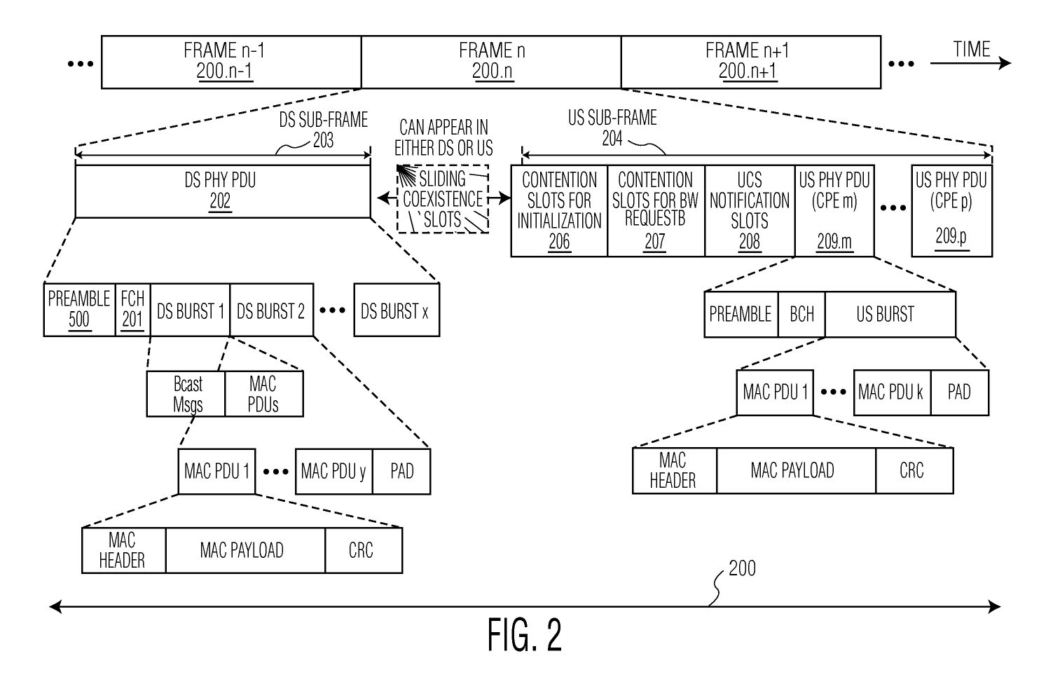

FIG. 2 illustrates frame structure;

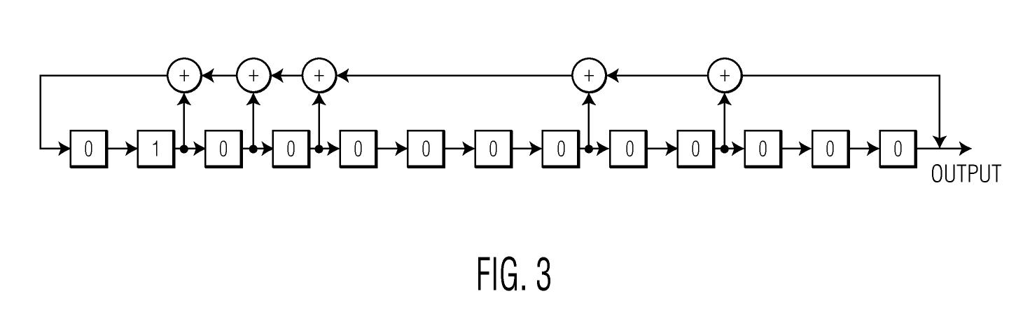

FIG. 3 illustrates pseudo random sequence generator;

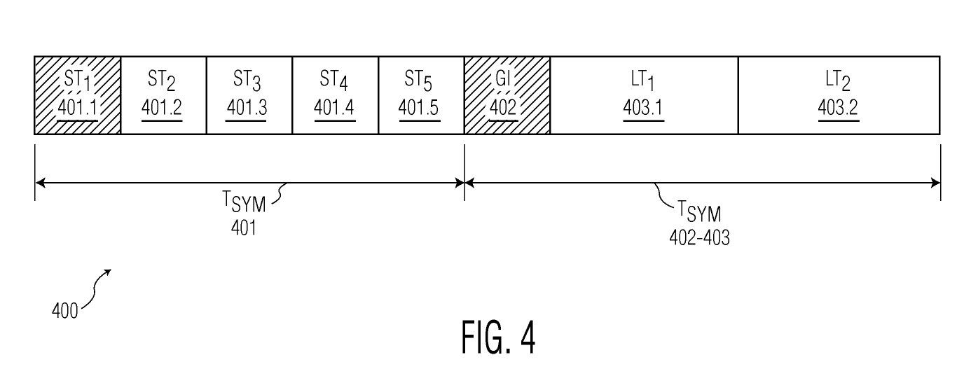

FIG. 4 illustrates Superframe preamble format wherein ST=short training sequence, LT=long training sequence;

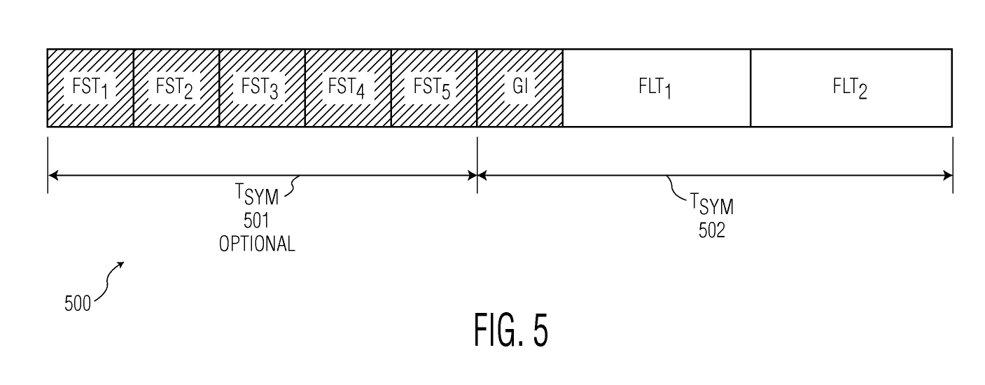

FIG. 5 illustrates frame preamble format wherein FST=frame short training sequence, FLT=frame long training sequence;

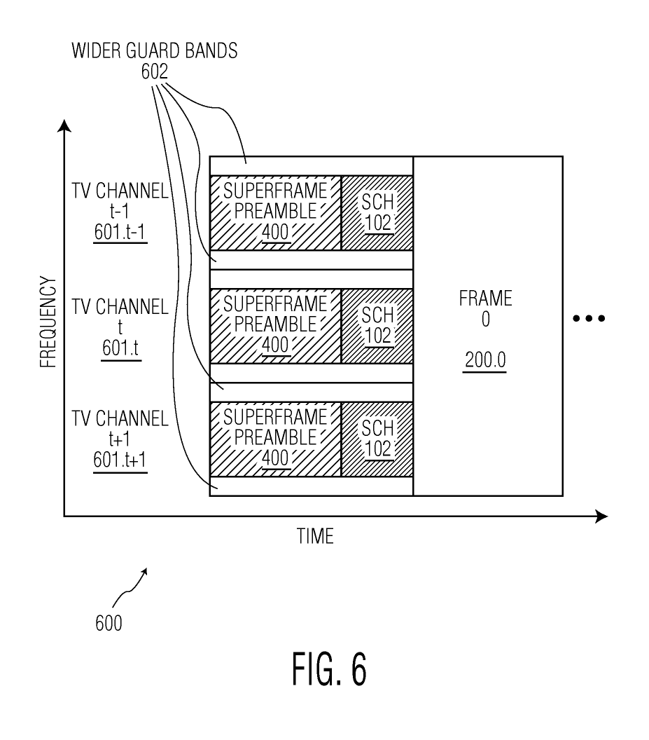

FIG. 6 illustrates wider guard bands in the superframe preamble and SCH;

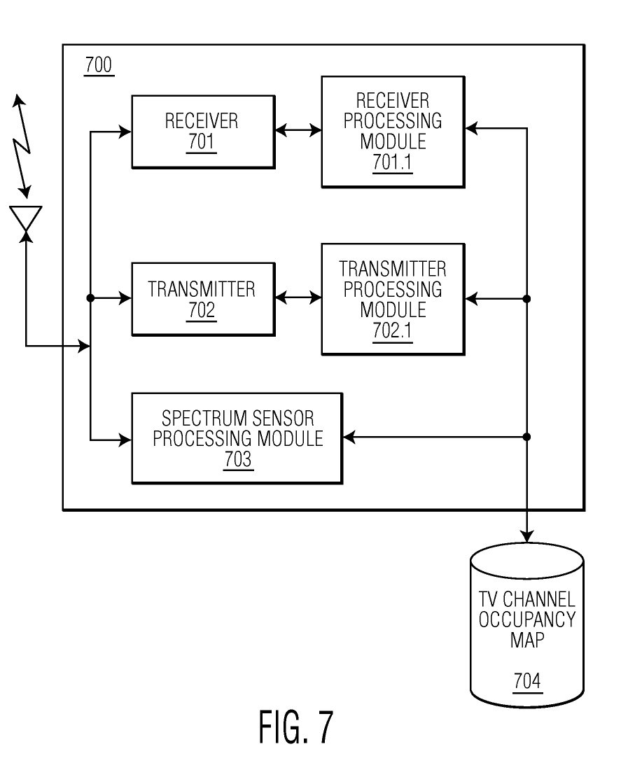

FIG. 7 illustrates a block diagram of a CPE modified according to the present invention;

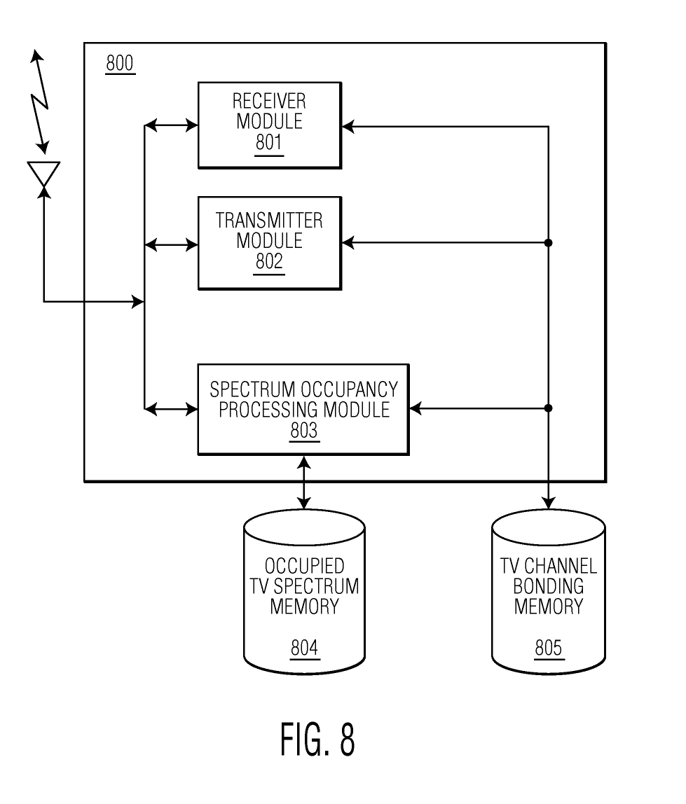

FIG. 8 illustrates a block diagram of a BS modified according to the present invention;

FIG. 9 illustrates a WRAN system of a BS and CPEs according to the present invention;

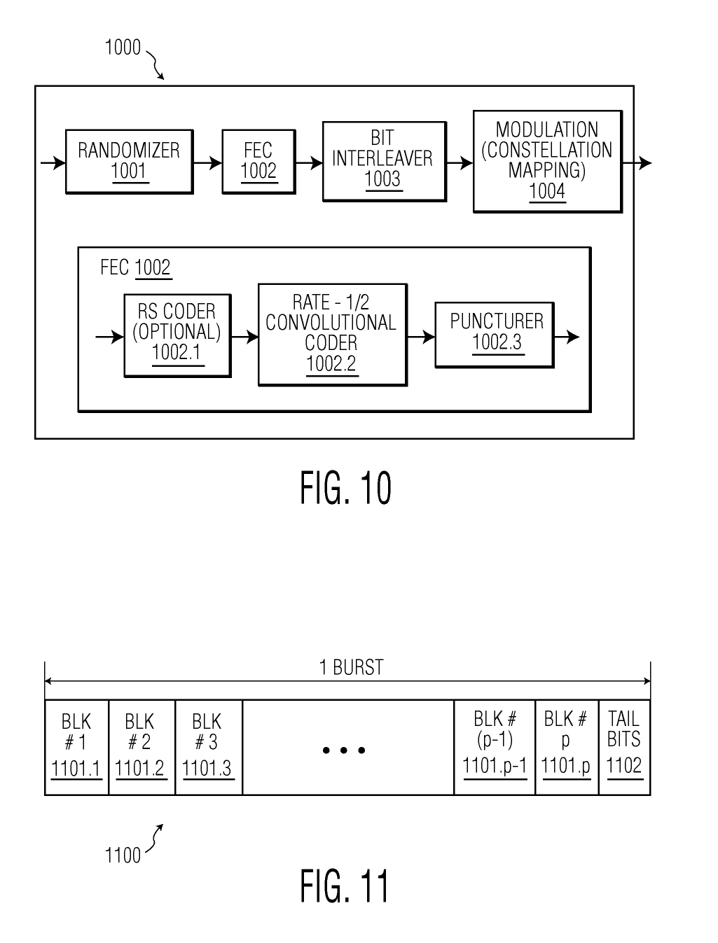

FIG. 10 illustrates a channel coding apparatus/process;

FIG. 11 illustrates a data burst sub-divided into data blocks; and

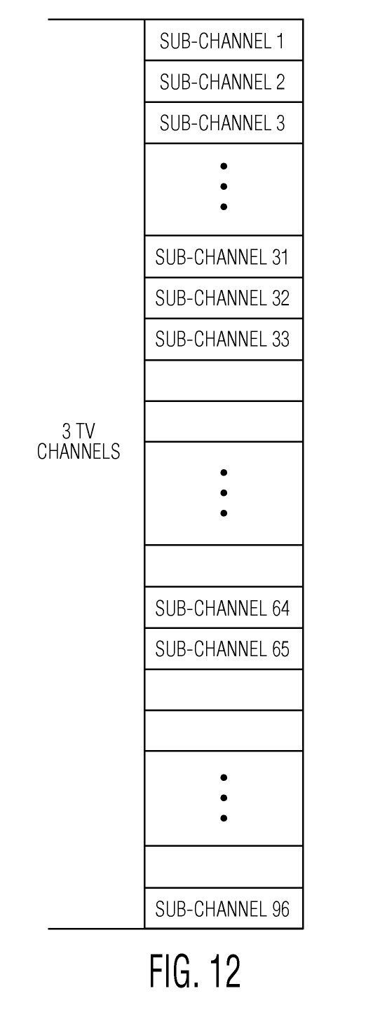

FIG. 12 illustrates sub-channel numbers.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and structure may be omitted from the current descriptions so as not to obscure the present invention.

The present invention provides superframe and frame structures, and preamble and control header definitions for a physical (PHY) layer the 802.22 WRAN specification.

Superframe and Frame Structure

A preferred embodiment employs a PHY superframe structure 100 and frame structure 200 as illustrated in FIG. 1 and FIG. 2, respectively. As shown in the superframe structure 100 of FIG. 1, the superframe transmission by a BS 800 begins with the transmission of a superframe preamble 400, followed by a superframe control header (SCH) 102. Since the superframe preamble 400 and the SCH 102 have to be received and decoded by all CPEs 700, the constituent fields include/transmit the same information in all the available bands. The SCH 102 includes information on the structure of the rest of the superframe 100. During each PHY superframe 100 the BS 800 manages all upstream and downstream transmission with respect to CPEs 700 in its cell 901.

In order to provide implementation simplicity (especially for the filters), both the superframe preamble 400 and the SCH 102 of a preferred embodiment includes an additional guard band at the band edges in each of these bands.

In a preferred embodiment, a top down PHY frame structure 200 is as illustrated in FIG. 2. As illustrated, the PHY frame 200 includes a predominantly downstream (DS) sub-frame 203 and an upstream (US) sub-frame 204. In a preferred embodiment, the boundary between these two sub-frames is adaptive to facilitate control of downstream and upstream capacity.

A DS sub-frame 203 includes a DS PHY PDU 202 with possible contention slots for coexistence purposes 205. In a preferred embodiment, there is a single DS sub-frame 203. A downstream PHY PDU 202 begins with a preamble 500 which is used for PHY synchronization. The preamble 500 is followed by an FCH burst 201 which specifies the burst profile and length of one or several downstream bursts immediately following the FCH 201.

A US sub-frame 204 includes fields for contention slots scheduled for initialization 206, bandwidth request 207, urgent coexistence situation notification 208, and at least one US PHY PDU 209.i, each of the latter transmitted from a different CPE 700. Preceding upstream CPE PHY bursts, the BS may schedule up to three contention windows:
Initialization window—used for ranging;
BW window—for CPEs to request US bandwidth allocation from the BS; and
UCS notification window—for CPEs to report and urgent coexistence situation with incumbents.

Preamble Definition

The frequency domain sequences for the preambles are derived from the following length 5184 vector. (Note that multiple reference sequences are defined, and a base station (BS) preferably selects one from this set. A CPE preferably obtains the information of the reference sequence during its initial set-up).

P_{REF}(−2592: −1)={ . . . }

P_{REF}(0)={0}

P_{REF}(1:2592)={ . . . }

P_{REF} is preferably generated by using a length-8191 pseudo random sequence generator and by forming QPSK symbols by mapping the first 5184 bits of this sequence to the I and Q components respectively. The generator polynomials of a preferred pseudo random sequence generator are illustrated in FIG. 3 and given are as

X¹³+X¹¹+X¹⁰+X⁹+X⁵+X³+1 and

X¹³+X¹¹+X¹⁰+1

The pseudo random generators are initialized with a value of 0 1000 0000 0000. FIG. 3 illustrates the pseudo noise generator for P_{REF}.

The first 32 output bits generated by the generator are 0000 0000 0001 0110 0011 1001 1101 0100 and the corresponding reference preamble symbols are given as

P_{REF}(−2592:2561)={−1−j, −1−j, −1−j, −1−j, −1−j, −1+j, −1−j, −1−j, −1+j, −1−j, −1−j, +1+j, −1−j, +1+j, +1−j, −1+j, −1−j, +1+j, +1+j, +1+j, −1+j, −1−j, +1−j, +1−j, +1−j, −1−j, +1+j, −1+j, +1−j, −1+j, −1+j}.

Superframe Preamble 400

The superframe preamble 400 is used by a receiver for frequency and time synchronization. Since the receiver also has to decode the SCH 102, the receiver needs to determine the channel response. Therefore, the superframe preamble 400 also includes a channel estimation field.

The format of the superframe preamble 400 is illustrated in FIG. 4. The superframe preamble 400 is 2 symbols in duration and includes 5 repetitions of the short training (ST) sequence 401.1-401.5 and 2 repetitions of the long training (LT) sequence 403.1-403.2. The guard interval 402 is only inserted at the beginning of the long training sequence. The length of the guard interval is given as

$${T}_{GI} = \frac{1}{4} {T}_{FFT} .$$

The duration of superframe preamble 400 is T_{superframe preamble}=740.522 μs for 6 MHz bandwidth modes.

The short training sequence 401 is generated from the above P_{REF} sequence using the following equation

$$\begin{matrix}{P}_{ST} ( k ) = \sqrt{\frac{4}{5} \times \frac{1728}{378}} {P}_{REF} ( k ) \vert k \vert \leq 756 , & and \vert k \vert mod 4 = 0 \\ 0 & otherwise\end{matrix}$$

This equation is used to generate 4 repetitions of a 512-sample vector. Another replica of this vector is transmitted in the GI 401.1. The factor

$$\sqrt{\frac{4}{5} \times \frac{1728}{378}}$$

is used to normalize the signal energy. Note that the superframe preamble symbols are transmitted at 3 dB higher power compared to the control and payload symbols. The short training sequence 401 is preferably used for initial burst detection, AGC tuning, coarse frequency offset estimation and timing synchronization.

The long training sequence 403 is preferably generated from the reference frequency domain sequence as shown below:

$$\begin{matrix}{P}_{LT} ( k ) = \sqrt{\frac{1728}{756}} {P}_{REF} ( k ) \vert k \vert \leq 756 , & and \vert k \vert mod 2 = 0 \\ 0 & otherwise\end{matrix}$$

This preferably generates 2 repetitions of a 1024-sample vector. The GI 402 precedes the long training sequence 403. The long training sequence 403 is used for channel estimation and for fine frequency offset estimation.

For both the short training sequence 401 and the long training sequence 403, the DC sub-carrier is preferably mapped to the center frequency of a single TV band. The superframe preamble 400 is transmitted/repeated in all the available bands, as illustrated in FIG. 6.

In situations where the BS determines to use only a single TV band, then P_{Frame,ST} is transmitted instead of P_{ST}, and P_{Frame,LT} is transmitted instead of P_{LT}.

Frame Preamble 500

The format of the frame preamble 500 is illustrated in FIG. 5. The frame preamble 500 preferably uses the T_{GI} specified by SCH 102.

The short (FST 501) and long training sequence (FLT 502) of the frame preamble 500 are derived according to the following equations

$$\begin{matrix}{P}_{Frame , ST} ( k ) = 2 \times \sqrt{\frac{4}{5}} {P}_{REF} ( k ) \vert k \vert \leq 864 \times {N}_{bands} , & and \vert k \vert mod 4 = 0 \\ 0 & otherwise\end{matrix}$$

$$\begin{matrix}{P}_{Frame , LT} ( k ) = \sqrt{2} {P}_{REF} ( k ) \vert k \vert \leq 864 \times {N}_{bands} , & and \vert k \vert mod 2 = 0 \\ 0 & otherwise\end{matrix}$$

where N_{bands} represents the number of bonded TV bands, as disclosed in copending application DKT6331 entitled “Bonding Adjacent TV Bands In A Physical Layer For IEEE 802.22 WRAN Communication Systems” by the same inventor and assigned to the same Assignee, the entire contents of which is hereby incorporated by reference as if fully set forth herein.

The duration of superframe 100 is relatively large and, as a result, the channel response may change within the superframe duration. Moreover the superframe preamble 400 is transmitted per band, while the frame 200 could be transmitted across multiple bands. In addition, some of the data carriers in the frame symbols are defined as guard sub-carriers in the superframe preamble.

Therefore, the channel estimates that were derived using the superframe preamble 400 may not be accurate for the frames 200. In addition, the channel estimation sequence is preferably used by the CPEs to re-initialize the fine frequency offset calculation. Therefore, the transmission of the long training sequence 502 in the frame preamble 500 is mandatory. In order to save system resources, a BS preferably chooses not to transmit the short training sequence 501 in the frame preamble 500 under certain conditions. This information is carried in the FCH 201 and is used to determine if the next frame's preamble 500 includes the short training sequence 401.

Coexistence Beacon Protocol (CBP) Preamble

The structure of the CBP preamble is similar to that of the Superframe preamble 400. The CBP preamble is preferably generated in a similar manner to the Superframe preamble 400 except that the last 5184 samples instead of the first 5184 samples from the 8191-length sequence are used to generate the I and Q components of the reference symbol sequence.

### Control Header and Map Definitions

Superframe Control Header (SCH) 102

The SCH 102 includes information such as the number of channels, number of frames, channel number, etc. It also includes a variable number of information elements (IEs), due to which the length of SCH is also variable (with a minimum of 19 bytes and a maximum of 42 bytes).

The SCH specification is shown in Table 1 and provides essential information and includes support for channel bonding, a certain control over the time a device takes to join the WRAN network, better coexistence with wireless microphone systems employing beacon signals, and so on. The ST field provide better coexistence among future wireless systems operating in the same band. It defines a way for systems to identify themselves and implement mechanisms for better coexistence. The CT field identifies the purpose for the transmission of the SCH. In 802.22, transmission of an SCH indicates two possible types of content may follow: a superframe 100 or a beacon. Therefore, the CT field is used to distinguish the type of content following the SCH. Further, this distinction is needed to support CBP which is employed to improve coexistence and sharing of the radio spectrum with other 802.22 systems. The use of the FS, Tx ID, CN and NC fields is straightforward and explained in Table 1. Since the SCH may contain further IEs, the Length field is used to specify the total length of the SCH.

The SCH 102 is encoded as follows.

Channel Coding

Channel coding includes data scrambling, RS coding (optional), convolutional coding, puncturing, bit interleaving and constellation mapping. FIG. 10 illustrates the mandatory channel coding process. The channel coder processes the control headers and the PSDU portion of the PPDU. The channel coder does not process the preamble part of the PPDU.

For the purpose of channel coding, each data burst is further sub-divided into data blocks as illustrated in FIG. 11. Each block of encoded data is mapped and transmitted on a sub-channel. In a preferred embodiment, distributed sub-carrier allocation is used to define sub-channels. In an alternative embodiment, contiguous sub-carrier allocation is used and multiple blocks of encoded data are mapped and transmitted on multiple sub-channels.

The output of the bit interleaver is entered serially to the constellation mapper. The input data to the mapper is first divided into groups of N_{CBPC} (2, 4 or 6) bits and then converted into complex numbers representing QPSK, 16-QAM or 64-QAM constellation points. The mapping is done according to Gray-coded constellation mapping. The complex valued number is scaled by a modulation dependent normalization factor K_{MOD}. Table 2 provides the K_{MOD} values for the different modulation types defined in this section. The number of coded bits per block (N_{CBPB}) and the number of data bits per block for the different constellation type and coding rate combinations are summarized in Table 3. Note that a block corresponds to the data transmitted in a single sub-channel.

TABLE 1
Superframe Control Header format

| Syntax | | Size | Notes |
|---|---|---|---|
| Superframe_Control_Header_Format( ) { | | | Transmitted with well-known |
| | | | modulation/coding (e.g., BPSK rate 1/2) |
| | ST | 7 bits | System Type |
| | | | Indicates the type of the system using this |
| | | | band. |
| | | | 0 = 802.22 WRAN |
| | | | 1 = Wireless Microphone |
| | | | 2 = 802.11 WLAN |
| | | | 3 = 802.15 WPAN |
| | | | 4 = 802.16 WMAN |
| | | | 5-127 = reserved |
| | CT | 1 bits | Content Type |
| | | | Indicates what is the type of the content that |
| | | | succeeds the transmission of the SCH. |
| | | | Superframe = 0 |
| | | | Beacon = 1 |
| | FS | 7 bits | Frames per Superframe |
| | | | Indicates the number of frames within a |
| | | | superframe. Typically, frames have a fixed |
| | | | size which preferably does not |
| | | | change. |
| | FDC | 8 bits | Frame Duration Code |
| | Reserved | 1 bit | Reserved |
| | Tx ID | 48 bits | Address that uniquely identifies the |
| | | | transmitter of the SCH (CPE or BS) |
| | CN | 8 bits | Channel Number |
| | | | Indicates the starting channel number in use |
| | | | by the transmitter |
| | NC | 8 bits | Number of Channels |
| | | | In case channel bonding is used, this field |
| | | | indicates the number of additional |
| | | | consecutive channels used by the transmitter. |
| | Length | 8 bits | The length of the SCH |
| | IEs | Variable | Information Elements |
| | | | Location configuration IE |
| | | | Timestamp IE |
| | | | and Common MAC IE |
| | HCS | 8 bits | Header Check Sequence |

}

TABLE 2
Modulation dependent normalization factor

| Modulation Type | N_{CBPC} | K_{MOD} |
|---|---|---|
| QPSK | 2 | 1/\sqrt{2} |
| 16-QAM | 4 | 1/\sqrt{10} |
| 64-QAM | 6 | 1/\sqrt{42} |

TABLE 3
The number of coded bits per block (N_{CBPB}) and the
number of data bits per block (N_{DBPB}) for the different
constellation type and coding rate combinations

| Constellation | | | |
|---|---|---|---|
| type | Coding rate | N_{CBPB} | N_{DBPB} |
| QPSK | ½ | 96 | 48 |
| QPSK | ¾ | 96 | 72 |
| 16-QAM | ½ | 192 | 96 |
| 16-QAM | 3/2 | 192 | 144 |
| 64-QAM | ¼ | 288 | 144 |
| 64-QAM | ⅔ | 288 | 192 |
| 64-QAM | ¾ | 288 | 216 |
| 64-QAM | ⅚ | 288 | 240 |

Spread OFDMA

A 16×16 matrix is used to spread the output of the constellation mapper. The type of the matrix to be used for different configurations is determined by the PHY mode parameter. For purpose of spreading, the output of constellation mapper is grouped into a symbol block of 16 symbols. Since each data block results in 48 symbols, a data block will generate 3 such symbol blocks.

The spreading is performed according to the following equation

S=CX

where X represents the constellation mapper output vector and is given as X=[x₁, x₂, . . . x₁₆]^{T},

S represents the spread symbols and which are defined as S=[s₁, s₂, . . . s₁₆]^{T}, and C=H₁₆ represents the hadamard spreading matrix and is given by the following Equation

$${H}_{{2}^{n}} = [ \begin{matrix}{H}_{{2}^{n - 1}} & {H}_{{2}^{n - 1}} \\ {H}_{{2}^{n - 1}} & - {H}_{{2}^{n - 1}}\end{matrix} ]$$

$$where$$

$${H}_{1} = [ 1 ] and {H}_{2} = [ \begin{matrix}1 & 1 \\ 1 & - 1\end{matrix} ] .$$

The spreading matrix C=I_{16×16}, an identity matrix, when non-spreading mode is selected.

Pilot Modulation

The pilots are mapped using QPSK constellation mapping. Spreading is not used on the pilots.

The pilots are defined as

$${S}_{p} ( k ) = \begin{matrix}{P}_{REF} ( k ) & k < 0 , and k ∈ pilot\_indices \\ 0 & otherwise\end{matrix}$$

$$and$$

$${S}_{p} ( k ) = \begin{matrix}conj ( {P}_{REF} ( - k ) ) & k > 0 , and k ∈ pilot\_indices \\ 0 & otherwise\end{matrix}$$

The SCH 102 is transmitted using the basic data rate mode. The 15-bit randomizer initialization sequence is set to all Is (i.e. 1111 1111 1111 111). The SCH 102 is decoded by all the CPEs 700 associated with that BS 800 (or in the region of that BS 800).

The SCH 102 is transmitted in all the sub-channels. Since the SCH 102 has to be decoded by all the CPEs 700 in the range of the BS 800, the SCH 102 has to be repeated in all the bands.

The 42 bytes of the SCH 102 are encoded by a rate-½ convolutional coder and after interleaving are mapped using QPSK constellation resulting in 336 symbols. In order to improve the robustness of the SCH 102 and to make better utilization of the available sub-carriers, spreading by a factor of 4 is applied to the output of the mapper. This results in 1344 symbols occupying 28 sub-channels.

This frees up 2 sub-channels on each of the band-edges, which are therefore defined as guard sub-channels. The location of these additional guard sub-carriers is the same as those defined above for a superframe header. The additional guard sub-carriers at the band-edges enable the CPEs to better decode the SCH 102. The 2K IFFT vector thus formed is replicated to generate the 4K and 6K length IFFT vectors.

Sub-Carrier Allocation for SCH

The SCH 102 uses only 28 sub-channels. The sub-carrier allocation is defined by the following equation.

$$SubCarrier ( n , k ) = {N}_{ch} \times ( k - 28 ) + ( n - 1 )$$

$$n = 1 , 2 , … , {N}_{ch} = 28$$

$$k = 1 , 2 , … , 27$$

$$SubCarrier ( n , k ) = {N}_{ch} \times ( k - 27 ) + ( n - 1 )$$

$$n = 1 , 2 , … , {N}_{ch} = 28 , \\ k = 28 , 29 , … , 54$$

The 6 pilot sub-carriers are then identified within each sub-channel. The pilot sub-carriers are distributed uniformly across the used sub-carriers in the SCH symbol. Every 9^{th} sub-carrier in the symbol is designated as the pilot sub-carrier. The sub-carrier indices of the pilots in the SCH 102 are: {−756, −747, −738, . . . , −18, −9, 9, 18, . . . , 738, 747, 756}. The rest of the sub-carriers in the sub-channel are then designated as data sub-carriers.

The superframe preamble 400 and the SCH 102 use only 756 sub-carriers on each side of DC sub-carrier, while the frame transmissions use 864 sub-carriers on each side of DC sub-carrier. As a result, the superframe preamble 400 and the SCH 102 include an additional guard band of 108 sub-carriers (equivalent to 108*ΔF=108*3376 Hz=364.608 kHz) at the band edges. FIG. 6 shows these wider guard bands 602 in the superframe preamble 400 and SCH 102.

Frame Control Header (FCH) 201

Referring now to FIG. 8, a BS 800 is illustrated in which the FCH 201 is transmitted by transmitter module 802 as part of the DS PPDU 202 in the DS sub-frame. The length of FCH 201 is 6 bytes and it contains, among others, the length (in bytes) information for DS-MAP, US-MAP, DCD and UDC. The FCH 201 is encoded by the transmitter module 802 and sent by the transmitter module 802 in the first two sub-channels in the symbol immediately following the frame preamble symbols 500.

The FCH 201 is transmitted by the transmitter module 802 using the basic data rate mode. The 15-bit randomizer is initialized using the 15 least significant bits (LSBs) of the BS identifier (ID). The BS ID is transmitted by the superframe transmitter 802 as part of the SCH 102 and is available to the CPEs 700. The 48 FCH bits are encoded and mapped onto 48 data sub-carriers in sub-channel #1 as described above for channel coding. In order to increase the robustness of the FCH 201, the encoded and mapped FCH data is re-transmitted in sub-channel #2, see FIG. 12. FIG. 12 illustrates a preferred sub-channel numbering scheme when 3 TV channels are bonded. Note that DC and guard sub-carriers are not shown in FIG. 12.

The frame control header (FCH) is transmitted in sub-channels 1 and 2. If S_{FCH,1}(k) represents the symbol transmitted on sub-carrier k in sub-channel 1, then the symbol transmitted on sub-channel k in sub-channel 2, S_{FCH,2}(k) is given as

S_{FCH,2}(k)=S_{FCH,1}((k+24), mod 48) k=0,1,2 . . . ,47

The BS 800 requests measurements of occupied spectrum by including the request in a superframe 100 transmitted by a superframe transmitter module 802 to all CPEs 700 within RF range of the BS 800. The BS 800 receives the responses from the CPEs 700, the responses being processed by the superframe receiver module 801 and stored in an occupied TV spectrum memory 804. The BS 800 sends instructions for channel usage to the CPEs 700 within RF range based on the contents of the occupied TV spectrum memory 804 and a TV channel bonding memory 805, the latter reflecting BS decisions concerning bonding up to three adjacent TV channels. The request for measurements is sent periodically by the BS 800 and reinstruction by the BS 800 of all CPEs 700 within RF range of the BS is possible on a periodic basis in order to avoid interference with incumbents.

Referring now to FIG. 7, in a preferred embodiment of a CPE 700, whenever a CPE 700 starts up, a spectrum sensor processing module 703 of the CPE 700 first scans the TV channels and builds a TV channel occupancy map 704 that identifies for each channel whether incumbents have been detected or not. The map 704 may be conveyed to a BS 800 and is also used by the spectrum sensor processing module 703 to determine which channels are vacant and hence use them to look for BSs 800.

In the vacant channels detected by the CPE 700, the spectrum sensor processing module 703 then scans for SCH 102 transmissions from a BS 800 from which the CPE acquires channel and network information that is used by the CPE 700 to associate with the BS 800, i.e., for network entry and initialization.

The CPE further comprises a receiver 701 and a receiver processing module 701.1 that combines corresponding symbols from the two sub-channels and decodes the FCH data to determine the lengths of the following fields in the frames. The CPE 700 also receives requests from a BS 800 for in-band and out-of-band measurements which are processed by the spectrum sensor processing module 703, responses being formatted and transmitted by the CPE in a superframe by a transmitter module 702. The CPE 700 receives instructions from a BS in Superframes 100 concerning which TV channels to use for subsequent transmissions by the CPE 700, including responses to measurement requests. In-band measurement relates to the channel(s) used by the BS to communicate with the CPE while out-of-band measurement relates to all other channels.

For in-band measurements the BS periodically quiets the channel so that incumbent sensing can be carried out, which is not the case for out-of-band measurements. The BS 800 includes a superframe transmitter module 803 for formatting and transmitting superframes that indicate which CPEs 700 measure which channel, for how long and in accordance with what probability of detection and false alarm. The BS 800 may distribute the measurement load across CPEs 700 and uses the measured values received in superframes 100 from the CPEs to obtain a spectrum occupancy map and store them in an occupied TV spectrum memory 804. The BS 800 then analyzes the measurements using a spectrum occupancy processing module and takes appropriate actions, e.g., bonding adjacent TV channels and storing the results in a TV channel bonding memory 805 and correspondingly informing the CPEs 700 by transmitting results in a subsequent superframe 100 by a superframe transmitter module 802.

FIG. 9 illustrates a WRAN deployment configuration modified according to the present invention, i.e., a plurality of overlapping WRAN cells 901 each of which includes a WRAN BS 800 modified/defined according to the present invention and at least one WRAN CPE 700 modified/defined according to the present invention. It is contemplated that the CPEs 700 are adapted to function in restricted frequency channels of a frequency band that requires protection of incumbent users. As such, the BSs 800 are secondary devices the WRAN cells 901 are secondary networks.

It is to be noted that while only a few CPEs 700, BSs 800, and WRAN cells 901 are shown, this is for simplicity of the discussion. Any number of any and all of these components of a WRAN is within the scope of the present invention.

The PHY layer of the present invention is expected to be implemented in dynamic remote environments where the availability and quality of channels varies over time and each WRAN cell of the example embodiments is expected to beneficially obtain channel availability in a dynamic manner with the PHY layer of the illustrative embodiments being used by BSs to provide spectrum access instructions to CPEs within their WRAN cells 901. Beneficially, the provided spectrum access instructions foster unfettered use of restricted TV channels/bands by the incumbent devices and BS-controlled access to same by the CPEs being controlled by the BSs.

The WRAN architecture 900 illustrated in FIG. 9 includes a plurality of PHY stacks that varies with the number of CPEs active in each WRAN cell 901. The PHY stacks provide a lower layer of the architecture and support upper layers, the latter including Medium Access Control (MAC), for example.

The plurality of PHY stacks are coupled to a spectrum occupancy processing module 803 which dynamically assigns these PHY stacks to respective groups of contiguous channels and thus indirectly assigns these PHY stacks to certain CPEs that are occupying those channels. Referring to FIG. 1, contiguous TV channels t−1 600.t−1 through t+1 600.t+1 are occupied by a WRAN. Notably, portions of the frequency spectrum between contiguous channels 601 occupied by a WRAN and those occupied by incumbent devices may remain unavailable or unused and wider guard bands 602 are used among and between contiguous channels 601 used by a WRAN.

Information is transferred between the spectrum occupancy processing module 803 and the plurality of PHY layers through well-defined interfaces that includes at least one of service primitive and application programming interfaces (APIs). The spectrum occupancy processing module 803 assigns available channels to the various PHY stacks, based on pre-determined criteria. To provide communication between BS 800 and CPEs 700 in a given WRAN cell 901 in order to achieve opportunistic TV channel usage under the control of the BS 800, the superframe and frame structures along with the control structure of the present invention are used by the BS 800. As described above and illustrated in FIGS. 1 and 6, the preamble 400 and SCH 102 of the superframe structure 100 are transmitted in parallel through a select few or all of the currently available restricted channels in use by the PHY stacks of the BS 800. That is, the preamble 400 and SCH 102 are transmitted in each of these channels at the commencement of the superframe 100. Thereafter, communications are carried out over the frames 200.n.0 through 200.n.m, i.e., superframe n includes m frames.

The availability of restricted TV channels to CPEs 700 of a WRAN cell 901 varies over time. Channels available at the start of one superframe may become unavailable and as a result in the next superframe transmitted by the BS 800, the preamble 400 and SCH 102 are changed by the PHY layer of the BS 800 to reflect this variation over time.

While the preferred embodiments of the present invention have been illustrated and described, it will be understood by those skilled in the art that the embodiment of the present invention as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the claims appended hereto as well as all implementation techniques.

I claim:

1. A WRAN communication system (900) including a base station (800) to manage a WRAN cell (900) that includes at least one consumer premise equipment (CPE) (700), comprising:
a superframe preamble (400) that is transmitted at the beginning of a superframe (100);
a superframe control header (SCH) (102) that is transmitted following said preamble (400);
at least one frame structure (200) having a downstream (DS) sub-frame (202) and an up-stream US sub-frame (204) that is transmitted following said SCH (102);
wherein, said base station (800) transmits a sequence of at least one said superframe (100) in parallel over each of at least one contiguous restricted TV channel occupied by said base station (800) to manage all upstream and downstream transmissions with respect said at least one CPE (700) of said WRAN cell (900) and such that said superframe preamble (400) and said SCH (102) each include an additional guard band at the band edges in each said at least one contiguous restricted TV channel.

2. The system of claim 1, wherein said at least one CPE (700) synchronizes with said base station (800) after receipt of said superframe (100).

3. The system of claim 2, wherein the superframe preamble (400) further comprises a short training (ST) sequence used by said CPE (700) for synchronization and a long training (LT) sequence used by said CPE (700) for channel estimation.

4. The system of claim 1, wherein a boundary between the DS sub-frame (203) and the US sub-frame (204) is adaptive to facilitate control of downstream and upstream capacity.

5. The system of claim 4, wherein the DS sub-frame (203) further comprises a DS PHY PDU (202) that includes:
a DS preamble (500) comprising a frame long training sequence (FLT) and an optional frame short training sequence (FST), said FLT being used by the at least one CPE (700) for channel estimation and, when present, said FST being used for synchronization of the at least one CPE (700) with said BS (800);
a frame control header (FCH) (201) that follows the DS preamble (500) said FCH including a profile and a length of a following at least one DS burst; and
at least one following DS burst that follows the FCH (201).

6. The system of claim 5, wherein the US sub-frame (204) may further comprise a component selected from the group consisting of:
at least one contention slot (206) scheduled for initialization;
at least one contention slot for a US bandwidth request by a CPE (700) to the BS (800); and
at least one urgent coexistence situation (UCS) notification window for a CPE (700) to report a UCS between the CPE and bandwidth incumbents; and
at least one US PHY PDU (209) from different CPEs (700) of the WRAN cell managed by the BS (800) and including a US preamble, a burst control header and a US burst.

7. The system of claim 6, wherein:
a plurality of sub-channels of a channel is defined using a technique selected from the group consisting of distributed sub-carrier allocation and contiguous sub-carrier allocation;
each DS burst and each US burst is sub-divided into at least one data block (1101.i); and
the at least one data block (1101.i) is transmitted on a sub-channel of the plurality of sub-channels.

8. A method for providing a physical layer in a WRAN communication system having a base station (BS) (800) to manage a WRAN cell (900) that includes at least one consumer premise equipment (CPE) (700), said BS occupying at least one contiguous restricted TV channel to manage all upstream and downstream transmissions with respect said at least one CPE (700) of said WRAN cell (900), comprising the steps of:
providing a superframe comprising:
a preamble (400) to be transmitted at the beginning of a superframe (100),
a superframe control header (SCH) (102) that is transmitted following said preamble (400), and
at least one frame structure (200) having a downstream (DS) sub-frame (202) and an up-stream US sub-frame (204) that is transmitted following said SCH (102);
transmitting a sequence of at least one said superframe (100) in parallel over each of said at least one contiguous restricted TV channel; and
including in each said transmitted superframe (100) an additional guard band at the band edges of each said at least one contiguous restricted TV channel for the superframe preamble (400) and the SCH (102) thereof.

9. The method of claim 8, further comprising the steps of:
receiving by said at least one CPE (700) of at least one superframe of said sequence; and
after receipt of said superframe (100) said CPE (700) synchronizing with said BS (800).

10. The method of claim 9, further comprising a step of said CPE (700) performing channel estimation after receipt of said superframe (100); and
wherein the superframe preamble (400) further comprises a short training (ST) sequence used by said synchronization step and a long training (LT) sequence used by said CPE (700) for said step of performing channel estimation.

11. The method of claim 9, further comprising the step of providing an adaptive boundary between the DS sub-frame (203) and the US sub-frame (204) to facilitate control of downstream and upstream capacity.

12. The method of claim 11, wherein the DS sub-frame (203) further comprises a DS PHY PDU (202) that includes:
a DS preamble (500) including a frame long training FLT sequence and an optional frame short training FST sequence, said FLT being used by the at least one CPE (700) for performing a step of channel estimation and, when present, said FST being used by the at least one CPE (700) for performing said step of synchronizing with said BS (800);
a frame control header (FCH) (201) that follows the DS preamble (500) said FCH including a profile and a length of a following at least one DS burst; and
at least one following DS burst that follows the FCH (201).

13. The method of claim 12, wherein the US sub-frame (204) may further comprise a component selected from the group consisting of:
at least one contention slot (206) scheduled for initialization;
at least one contention slot for a US bandwidth request by a CPE (700) to the BS (800);
at least one urgent coexistence situation (UCS) notification window for a CPE (700) to report a UCS between the CPE and bandwidth incumbents; and
at least one US PHY PDU (209) from different CPEs (700) of the WRAN cell managed by the BS (800) and including a US preamble, a burst control header and a US burst.

14. The method of claim 13, further comprising the steps of
defining a plurality of sub-channels of a channel using a technique selected from the group consisting of distributed sub-carrier allocation and contiguous sub-carrier allocation;
sub-dividing each DS burst and each US burst into at least one data block (1101.i); and
transmitting the at least one data block (1101.i) in a sub-channel of the plurality of defined sub-channels.

15. A base station BS (800) for managing a WRAN cell (900) including at least one consumer premises equipment (700), comprising:
a PHY superframe structure (100) that includes a superframe preamble (400) transmitted at a beginning of the PHY superframe structure (100), a superframe control header (SCH) (102) transmitted following the superframe preamble (400), and at least one frame structure (200) transmitted following the SCH (102) such that the frame structure (200) includes a downstream (DS) sub-frame (202) and an up-stream (US) sub-frame;
a receiver module (801) for reception processing of a received superframe formatted according to the PHY superframe structure (100);
a transmitter module (802)
(a) for transmission processing of a PHY superframe, formatted according to the PHY superframe structure (100) and transmitted by said transmitter component (802) such that the preamble (400) and SCH (102) thereof are transmitted in parallel over each of at least one contiguous restricted TV channel being occupied by the BS (800), and include in each said transmitted PHY superframe (100) an additional guard band at the band edges of each said at least one contiguous restricted TV channel for the superframe preamble (400) and the SCH (102) thereof, and
(b) for scheduling up to three contention windows at the beginning of the US sub-frame (204) selected from the group consisting of
1. an initialization window used for ranging (206),
2. a bandwidth window (207) used by the CPE (700) to request upstream bandwidth allocation from the BS (800), and
3. an urgent coexistence situation (UCS) notification window to report to the BS (800) an urgent coexistence situation with incumbents;
wherein said BS (800) manages all upstream and downstream transmissions with respect to said at least one CPE (700).

16. A consumer premise equipment (CPE) (700) for a WRAN communication system (900) controlled by a BS (800), comprising:
a PHY superframe structure (100) that includes a superframe preamble (400) transmitted at the beginning of the PHY superframe, followed by a superframe control header (SCH) (102) transmitted following the preamble (400), wherein the preamble (400) and SCH (102) are transmitted/received in parallel over each of at least one contiguous restricted TV channel being occupied by the BS (800)
at least one frame structure (200) transmitted following the SCH (102), such that the frame structure (200) includes:
(a) a downstream (DS) sub-frame (202), and
(b) an up-stream (US) sub-frame (204),
wherein up to three contention windows may be scheduled at the beginning of the US sub-frame:
1. an initialization window used for ranging,
2. a bandwidth window (207) used by the CPE (700) to request upstream bandwidth allocation from the BS (800), and
3. and an urgent coexistence situation (UCS) notification window to report to the BS (800) an urgent coexistence situation with incumbents;
a receiver component (701) having a receiver processing module (701.1) for reception processing of a received superframe formatted according to the PHY superframe structure (100); and
a transmitter component (202) having a transmitter processing module (702.1) for transmission processing of a PHY superframe, formatted according to the PHY superframe structure (100) and transmitted by said transmitter component (802).
